(19) United States
(12) Patent Application Publication
(10) Pub. No.: US 2024/0243797 A1
(43) Pub. Date: Jul. 18, 2024

(54) SPATIAL DOMAIN SIMULTANEOUS OPERATION IN SOFT RESOURCES IN IAB

(71) Applicant: Telefonaktiebolaget LM Ericsson (publ), Stockholm (SE)

(72) Inventors: Magnus Åström, Lund (SE); Erik Dahlman, Stockholm (SE); Lei Bao, Göteborg (SE); Boris Dortschy, Vendelsö (SE); Behrooz Makki, Pixbo (SE)

(21) Appl. No.: 18/289,584

(22) PCT Filed: May 9, 2022
(86) PCT No.: PCT/EP2022/062447

§ 371 Date: Nov. 6, 2023

Related U.S. Application Data
(60) Provisional application No. 63/187,258, filed on May 11, 2021.

(51) Int. Cl. H04B 7/06; H04B 7/024; H04L 5/00; H04W 72/044; H04W 88/08

(52) U.S. Cl. CPC H04B 7/06966; H04B 7/024; H04L 5/0048; H04W 72/046; H04W 88/085

(57) ABSTRACT

Systems and methods are disclosed for spatial domain simultaneous operation in an Integrated Access and Backhaul (IAB) node. In one embodiment, a method performed by an IAB-node for spatial domain simultaneous operation with a parent IAB-node and a child IAB-node or a wireless communication device (WCD) comprises transmitting reference signals in reference transmit beams and receiving, from the parent IAB-node, a beam restriction configuration related to the reference transmit beams, the beam restriction configuration comprising information that indicates a set of restricted beams for simultaneous spatial domain operation. Corresponding embodiments of an IAB-node are also disclosed. Embodiments of a parent IAB-node and embodiments of a method of operation thereof are also disclosed.

### RELATED APPLICATIONS

This application claims the benefit of provisional patent application Ser. No. 63/187,258, filed May 11, 2021, the disclosure of which is hereby incorporated herein by reference in its entirety.

### TECHNICAL FIELD

The present disclosure relates to an Integrated Access and Backhaul (IAB) deployment of a Radio Access Network (RAN) in a cellular communications system.

### BACKGROUND

### Integrated Access and Backhaul Overview

Densification via the deployment of increasing base stations, be them macro or micro base stations, is one of the mechanisms that can be employed to satisfy the ever-increasing demand for more and more bandwidth/capacity in mobile networks. Due to the availability of more spectrum in the millimeter wave (mmW) band, deploying small cells that operate in this band is an attractive deployment option for these purposes. However, deploying fiber to the small cells, which is the usual way in which small cells are deployed, can end up being very expensive and impractical. Thus, employing a wireless link for connecting the small cells to the operator's network is a cheaper and practical alternative with more flexibility and shorter time-to-market. One such solution is an Integrated Access and Backhaul (IAB) network, where the operator can utilize part of the radio resources for the backhaul link.

In FIG. 1, an IAB deployment that supports multiple hops is presented. The IAB-donor has a, e.g., wired connection to the core network, and the IAB-nodes are wirelessly connected using New Radio (NR) to the IAB-donor, either directly or indirectly via another IAB-node. The connection between IAB-donor/node and User Equipments (UEs) is called access link, whereas the connection between two IAB-nodes or between an IAB-donor and an IAB-node is called backhaul link.

Furthermore, as shown in FIG. 2, the adjacent upstream node which is closer to the IAB-donor of an IAB-node is referred to as a parent node (or parent IAB-node) of the IAB-node. The adjacent downstream node which is further away from the IAB-donor of an IAB-node is referred to as a child node (or child IAB-node) of the IAB-node. The backhaul link between the parent node and the IAB-node is referred to as parent (backhaul) link, whereas the backhaul link between the IAB-node and the child node is referred to as child (backhaul) link.

### IAB Architecture

As one major difference of the IAB architecture compared to a Release 10 Long Term Evolution (LTE) relay (besides lower layer differences) is that the IAB architecture adopts the Central-Unit/Distributed-Unit (CU/DU) split of NR base stations (gNBs) in which time-critical functionalities are realized in IAB-DU closer to the radio, whereas the less time-critical functionalities are pooled in the CU with the opportunity for centralization. Based on this architecture, an IAB-donor contains both CU and DU functions. In particular, it contains all CU functions of the IAB-nodes under the same IAB-donor. Each IAB-node then hosts the DU function(s) of a gNB. In order to be able to transmit/receive wireless signals to/from the upstream IAB-node or IAB-donor, each IAB-node has a Mobile Termination (MT), a logical unit providing a necessary set of UE-like functions. Via the IAB-DU, the IAB-node establishes Radio Link Control (RLC) channels to UEs and/or to MTs of the connected IAB-node(s). Via the IAB-MT, the IAB-node establishes the backhaul radio interface towards the serving IAB-node or IAB-donor. FIG. 3 shows a reference diagram for a two-hop chain of IAB-nodes under an IAB-donor.

### IAB Topologies

Wireless backhaul links are vulnerable to blockage, e.g., due to moving objects such as vehicles, due to seasonal changes (foliage), severe weather conditions (rain, snow, or hail), or due to infrastructure changes (new buildings). Such vulnerability also applies to IAB-nodes. Also, traffic variations can create uneven load distribution on wireless backhaul links leading to local link or node congestion. In view of those concerns, the IAB topology supports redundant paths as another difference compared to the Rel-10 LTE relay.

The following topologies are considered in IAB as shown in FIG. 4:
Spanning tree (ST)
Directed acyclic graph (DAG)

One IAB-node can have multiple child nodes and/or have multiple parent nodes. Particularly regarding multi-parent topology, different scenarios may be considered as shown in FIG. 5. For example:
IAB-9 connects to IAB-donor 1 via two parent nodes IAB-5 and IAB-6 which connect to the same grandparent node IAB-1;
IAB-10 connects to IAB-donor 1 via two parent nodes IAB-6 and IAB-7 which connect to different grandparent nodes IAB-1 and IAB-2;
IAB-8 connects to two parent nodes IAB-3 and IAB-4 which connect to different IAB-donors IAB-donor 1 and IAB-donor 2.

The multi-connectivity or route redundancy may be used for back-up purposes. It is also possible that redundant routes are used concurrently, e.g., to achieve load balancing, reliability, etc.

According to the IAB Third Generation Partnership Project (3GPP) Technical Report (TR) 38.874 V16.0.0, when operating in standalone mode (SA-mode), an NR+NR dual connected IAB-node can add redundant routes by establishing a Master Cell Group (MCG) link (MCG-link) to one parent node IAB-DU and a Secondary Cell Group (SCG) link (SCG-link) to another parent node IAB-DU. The dual-connecting IAB-MT will enable the SCG link using the Release 15 NR Dual Connectivity (NR-DC) procedures.

### Resource Coordination

In case of in-band operation, the IAB-node is typically subject to the half-duplex constraint, i.e., an IAB-node can only be in either transmission or reception mode at a given time. Release 16 IAB mainly consider the Time-Division Multiplexing (TDM) case where the IAB-MT and IAB-DU resources of the same IAB-node are separated in time. Based on this consideration, the following resource types have been defined for IAB-MT and IAB-DU, respectively.

From an IAB-MT point-of-view, as in Release 15, the following time-domain resources can be indicated for the parent link:
1) Downlink (DL) time resource
2) Uplink (UL) time resource
3) Flexible (F) time resource

From an IAB-DU point-of-view, the child link has the following types of time resources:
1) DL time resource
2) UL time resource
3) F time resource
4) Not-available (NA) time resources (resources not to be used for communication on the DU child links)

Each of the downlink, uplink, and flexible time-resource types of the DU child link can belong to one of two categories:
Hard (H): The corresponding time resource is always available for the DU child link
Soft (S): The availability of the corresponding time resource for the DU child link is explicitly and/or implicitly controlled by the parent node.

The IAB-DU resources are configured per cell, and the H/S/NA attributes for the IAB-DU resource configuration are explicitly indicated per-resource type (D/U/F) in each slot. As a result, the semi-static time-domain resources of the IAB-DU part can be of seven types in total: Downlink-Hard (DL-H), Downlink-Soft (DL-S), Uplink-Hard (UL-H), Uplink-Soft (UL-S), Flexible-Hard (F-H), Flexible-Soft (F-S), and Not-Available (NA). The coordination relation between IAB-MT and IAB-DU resources are listed in Table 1.

TABLE 1
Coordination between IAB-MT and IAB-DU resources of an IAB-node.

| | | IAB-MT configuration | | |
|---|---|---|---|---|
| | | DL | UL | Flexible |
| DU | DL-H | DU: can transmit on | DU: can transmit on | DU: can transmit on |
| configuration | | DL unconditionally; | DL unconditionally; | DL unconditionally; |
| | | MT: not available. | MT: not available. | MT: not available. |
| | DL-S | DU: can transmit | DU: can transmit | DU: can transmit |
| | | conditionally; | conditionally; | conditionally; |
| | | MT: available on DL. | MT: available on UL. | MT: available on DL |
| | | | | & UL. |
| | UL-H | DU: can schedule UL | DU: can schedule UL | DU: can schedule UL |
| | | unconditionally; | unconditionally; | unconditionally; |
| | | MT: not available. | MT: not available. | MT: not available. |
| | UL-S | DU: can schedule UL | DU: can schedule UL | DU: can schedule UL |
| | | conditionally; | conditionally; | conditionally; |
| | | MT: available on DL. | MT: available on UL. | MT: available on DL |
| | | | | & UL. |
| | F-H | DU: can transmit on | DU: can transmit on | DU: can transmit on |
| | | DL or schedule UL | DL or schedule UL | DL or schedule UL |
| | | unconditionally; | unconditionally; | unconditionally; |
| | | MT: not available. | MT: not available. | MT: not available. |
| | F-S | DU: can transmit on | DU: can transmit on | DU: can transmit on |
| | | DL or schedule UL | DL or schedule UL | DL or schedule UL |
| | | conditionally; | conditionally; | conditionally; |
| | | MT: available on DL. | MT: available on UL. | MT: available on DL |
| | | | | & UL. |
| | NA | DU: not available; | DU: not available; | DU: not available; |
| | | MT: available on DL. | MT: available on UL. | MT: available on DL |
| | | | | & UL. |

In Release 16 IAB, there are two ways for the parent IAB-nodes to indicate the availability of the soft time-domain DU resource: implicit indication and explicit indication. This is identified in the following part of the 3GPP Technical Specification (TS) 38.213 specification:

**********Start Excerpt from 3Gpp TS 38.213**********
With reference to slots of an IAB-DU cell, a symbol in a slot of an IAB-DU cell can be configured to be of hard, soft, or unavailable type. When a downlink, uplink, or flexible symbol is configured as hard, the IAB-DU cell can respectively transmit, receive, or either transmit or receive in the symbol.
When a downlink, uplink, or flexible symbol is configured as soft, the IAB-DU cell can respectively transmit, receive or either transmit or receive in the symbol only if
the IAB-MT does not transmit or receive during the symbol of the IAB-DU cell, or
the IAB-MT would transmit or receive during the symbol of the IAB-DU cell, and the transmission or reception during the symbol of the IAB-DU cell is not changed due to a use of the symbol by the IAB-DU, or
the IAB-MT detects a DCI format 2_5 with an AI index field value indicating the soft symbol as available
   **********End Excerpt from 3Gpp TS 38.213**********

The explicit indication, the third bullet above, referred to as Availability Indication (AI), uses DCI Format 2_5 for dynamically indicating the availability of IAB-DU Soft resource in a slot. The first two bullets above determine availability based on implicit indication, where particularly the second bullet states that the IAB-DU may use a symbol provided it does not change (interfere) with any transmission or reception that the IAB-MT may be part in.

### Rel-17 Objective Regarding Simultaneous Operation

The above refers to the Release 16 IAB specification. In the Release 17 enhanced IAB WID, the following duplexing enhancements are specified:
Specification of enhancements to the resource multiplexing between child and parent links of an IAB-node, including:
   Support of simultaneous operation (transmission and/or reception) of IAB-node's child and parent links (i.e., MT Tx/DU Tx, MT Tx/DU Rx, MT Rx/DU Tx, MT Rx/DU Rx).

As part of this, RAN1 agreed in RAN1 #104bis-e to extend support for H/S/NA resource availability indication to the frequency domain:

### Agreement

The extension of the semi-static DU resource type indication to frequency-domain resources within a carrier (in addition to existing Rel-16 per-carrier granularity) for H/S/NA resource types is supported.
Soft resource availability indications for frequency-domain resources are supported.

Hence, the above explicit and implicit availability indication in 3GPP TS 38.213 will need to also accommodate frequency domain operation, and the carrier will be partitioned into Hard, Soft, or Not Available parts, possibly also related to slot directivity (DL, UL, F), see FIG. 6.

The NR beam management framework is designed to determine suitable beams for transmission and reception. At mmW where analog beamforming is used, the candidate beams are tested using a fixed grid-of-beam scheme. A UE is informed by the network about the quasi co-located (QCL) relation between the downlink (DL) channels (Physical Downlink Control Channel (PDCCH)/Physical Downlink Shared Channel (PDSCH)) and the DL reference signals (e.g., Synchronization Signal Blocks (SSBs) and Channel State Information Reference Signals (CSI-RSs)), as well as the spatial relation between the uplink (UL) channels (Physical Uplink Control Channel (PUCCH)/Physical Uplink Shared Channel (PUSCH)) and the UL reference signals (e.g., Sounding Reference Signal (SRS)).

In the initial beam establishment step (P1), the gNB transmits SSB signals in wide SSB beams. The UE finds a suitable SSB Receive (RX) beam and transmits Physical Random Access Channel (PRACH) with this SS beam. The gNB will accordingly determine a suitable RX beam to receive PRACH. After the initial beam establishment, the gNB, in the second step (P2), transmits CSI-RS in different candidate beams and, based on the measurement reports from UE, the suitable Transmit (TX) serving beams for PDCCH/PDSCH transmission will be identified. In the third step (P3), the gNB transmits CSI-RS in the serving beam, and the UE adjusts the RX beams based on the measurement results on the reference signals.

For UL transmission, beam correspondence means a node can derive the TX beam from RX beam or vice versa. In most cases, it is expected that beam correspondence can be used at the gNB or a UE. In case beam correspondence is not fulfilled, the UE needs to sweep for example SRS in candidate beams to determine suitable beams for UL transmission.

### SUMMARY

Systems and methods are disclosed for spatial domain simultaneous operation in an Integrated Access and Backhaul (IAB) node. In one embodiment, a method performed by an IAB-node for spatial domain simultaneous operation with a parent IAB-node and a child IAB-node or a wireless communication device (WCD) comprises transmitting reference signals in reference transmit beams and receiving, from the parent IAB-node, a beam restriction configuration related to the reference transmit beams, the beam restriction configuration comprising information that indicates a set of restricted beams for simultaneous spatial domain operation. In this manner, the IAB-node is enabled to operate in a spatial domain simultaneous operation mode, meaning that both the Mobile Termination (MT) and the Distributed Unit (DU) of the IAB can operate (transmit and/or receive) using the same time-frequency resources.

In one embodiment, the set of restricted beams consists of one or more beams that are restricted from being used by a Distributed Unit (DU) of the IAB-node together with a current serving beam of a Mobile Termination (MT) of the IAB-node for simultaneous spatial domain operation.

In one embodiment, the method further comprises, prior to transmitting the reference signals in the reference transmit beams, transmitting a capability report to an associated central unit (CU), wherein the capability report comprises information that indicates a capability of the IAB-node for spatial domain simultaneous operation. In one embodiment, the method further comprises, prior to transmitting the reference signals in the reference transmit beams, receiving a Hard, Soft, and Not Available resource configuration from the CU, wherein the Hard, Soft, and Not Available resource configuration is a time domain resource configuration, a frequency domain resource configuration, or a combined time domain and frequency domain resource configuration and indicates which time, frequency, or both time and frequency resources are allowed, conditionally allowed, or disallowed to be used by a DU of the IAB-node.

In one embodiment, the method further comprises, upon receiving the beam restriction configuration, identifying a need for communicating with a child IAB-node or a wireless communication device, determining a serving beam towards the child IAB-node or the wireless communication device based on the beam restriction configuration, scheduling resources for one or more operations towards the child IAB-node or the wireless communication device, and transmitting or receiving data to or from the child IAB-node or the wireless communication device on the scheduled resources using the determined serving beam. In one embodiment, the scheduled resources are resources that are available for use by the DU subject to control by the CU or resources that are always available for use by the DU. In one embodiment, the method further comprises, prior to determining the serving beam, upon receiving an availability indicator for a Soft resource from the parent IAB-node, scheduling the child IAB-node or the wireless communication device even if the determined serving beam is a restricted beam.

In one embodiment, the reference signals comprise synchronization signal blocks (SSBs), channel state information reference signals (CSI-RSs), sounding reference signals (SRSs), or any combination thereof.

In one embodiment, receiving the beam restriction configuration comprises receiving the beam restriction configuration via a Medium Access Control (MAC) Control Element (CE).

In one embodiment, the beam restriction configuration is received from the parent IAB-node or the CU.

Corresponding embodiments of an IAB-node are disclosed. In one embodiment, an IAB-node for spatial domain simultaneous operation with a parent IAB-node and a child IAB-node or a WCD, the IAB-node comprising processing circuitry configured to cause the IAB-node to transmit reference signals in reference transmit beams and receive, from the parent IAB-node, a beam restriction configuration related to the reference transmit beams, the beam restriction configuration comprising information that indicates a set of restricted beams for simultaneous spatial domain operation.

Embodiments of a method performed by a parent IAB-node are also disclosed. In one embodiment, a method performed by a parent IAB-node for communicating with an IAB-node capable of spatial domain simultaneous operation comprises receiving reference signals in reference transmit beams from an IAB-node using a serving receive beam, determining a set of restricted beams for spatial domain simultaneous operation, and signaling a configuration to the IAB-node, the configuration comprising information that indicates the set of restricted beams.

In one embodiment, the set of restricted beams consists of one or more beams that are restricted from being used by a DU of the IAB-node together with a current serving beam of a MT of the IAB-node for simultaneous spatial domain operation.

In one embodiment, the method further comprises, prior to receiving the reference signals, receiving information that indicates that the IAB-node is capable of spatial domain simultaneous operation.

In one embodiment, the reference signals comprise SSBs, CSI-RSs, SRSs, or any combination thereof.

In one embodiment, signaling the configuration to the IAB-node comprises signaling the configuration to the IAB-node via a MAC CE.

Corresponding embodiments of a parent IAB-node are also disclosed. In one embodiment, a parent IAB-node for communicating with an IAB-node capable of spatial domain simultaneous operation comprises processing circuitry configured to cause the parent IAB-node to receive reference signals in reference transmit beams from an IAB-node using a serving receive beam, determine a set of restricted beams for spatial domain simultaneous operation, and signal a configuration to the IAB-node, the configuration comprising information that indicates the set of restricted beams.

In another embodiment, a method performed by an IAB-node for spatial domain simultaneous operation with a parent IAB-node and a child IAB-node or a WCD comprises receiving a reference signal in a serving transmit beam from a parent IAB-node by sweeping multiple reference receive beams and determining a set of restricted receive beams for spatial domain simultaneous operation.

In one embodiment, the method further comprises, prior to receiving the reference signal, transmitting a capability report to a CU, the capability report comprising information that indicates a capability of the IAB-node for spatial domain simultaneous operation.

In one embodiment, the method further comprises receiving a Hard, Soft, and Not Available resource configuration from the CU, wherein the Hard, Soft, and Not Available resource configuration is a time domain resource configuration, a frequency domain resource configuration, or a combined time domain and frequency domain resource configuration and indicates which time, frequency, or both time and frequency resources are allowed, conditionally allowed, or disallowed to be used by a DU of the IAB-node.

In one embodiment, the method further comprises identifying a need for communicating with a child IAB-node or a wireless communication device, determining a serving receive beam towards the child IAB-node or wireless communication device based on the determined set of restricted receive beams for spatial domain simultaneous operation, scheduling resources for one or more operations towards the child IAB-node or wireless communication device, and transmitting or receiving data to or from the child IAB-node or wireless communication device on the scheduled resources using the determined serving beam.

In one embodiment, the method further comprises, upon receiving an availability indicator for a Soft resource from the parent IAB-node, scheduling the child IAB-node or wireless communication device even if the determined serving beam is a restricted beam.

Corresponding embodiments of an IAB node are disclosed. In one embodiment, an IAB-node for spatial domain simultaneous reception with a parent IAB-node and a child IAB-node or a WCD comprises processing circuitry configured to cause the IAB-node to receive a reference signal in a serving transmit beam from a parent IAB-node by sweeping multiple reference receive beams and determine a set of restricted receive beams for spatial domain simultaneous operation.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an Integrated Access and Backhaul (IAB) deployment that supports multiple hops;

FIG. 2 illustrates various terminology used for nodes and links in an IAB deployment;

FIG. 3 shows a reference diagram for a two-hop chain of IAB-nodes under an IAB-donor;

FIG. 4 illustrates two topologies considered in IAB;

FIG. 5 illustrates various scenarios in a multi-parent IAB topology;

FIG. 6 illustrates an example subcarrier configuration and IAB Distributed Unit (DU) operation;

FIG. 7 illustrates one example of an IAB deployment of a radio access network (RAN), which is also referred to herein as an IAB network, in which embodiments of the present disclosure may be implemented;

FIG. 8 is an illustration of example Synchronization Signal Block (SSB) beams of an IAB-node and serving beams of parent and child IAB-nodes;

FIG. 9 is an illustration of example received signal strength of different SSB beams at the parent IAB-node of FIG. 8;

FIG. 10 is a flow chart that illustrates the operation of an IAB-node for communicating with a parent IAB-node and a child IAB-node or wireless communication device in a simultaneous spatial domain operation mode in accordance with one embodiment of the present disclosure;

FIG. 11 is a flow chart that illustrates the operation of a parent IAB-node for communicating with an IAB-node that communicates with the parent IAB-node and a child IAB-node or wireless communication device in a simultaneous spatial domain operation mode in accordance with one embodiment of the present disclosure;

FIG. 12 is a flow chart that illustrates the operation of an IAB-node for communicating with a parent IAB-node and a child IAB-node or wireless communication device in a simultaneous spatial domain operation mode in accordance with another embodiment of the present disclosure;

FIGS. 13 and 14 are schematic block diagrams of example embodiments of an IAB-node in which embodiments of the present disclosure may be implemented;

FIG. 15 illustrates an example embodiment of a communication system in which embodiments of the present disclosure may be implemented;

FIG. 16 illustrates example embodiments of the host computer, base station, and UE of FIG. 15;

FIGS. 17, 18, 19, and 20 are flow charts that illustrate example embodiments of methods implemented in a communication system such as that of FIG. 15.

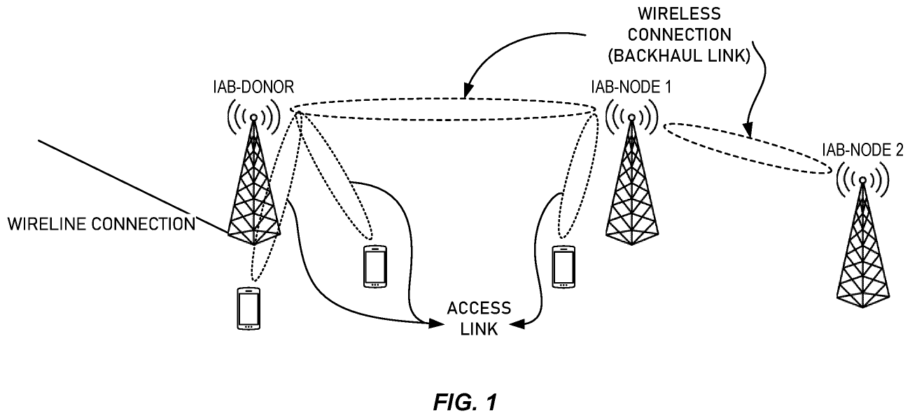

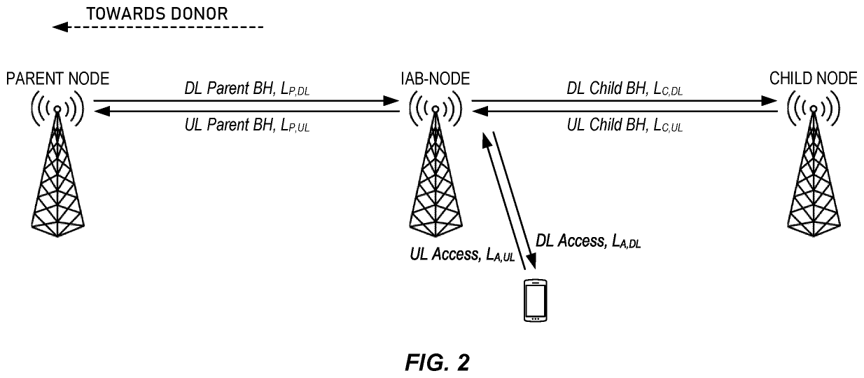

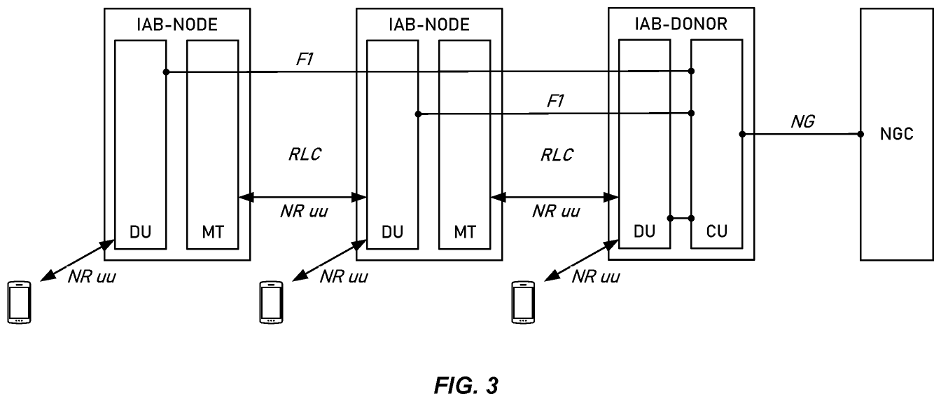

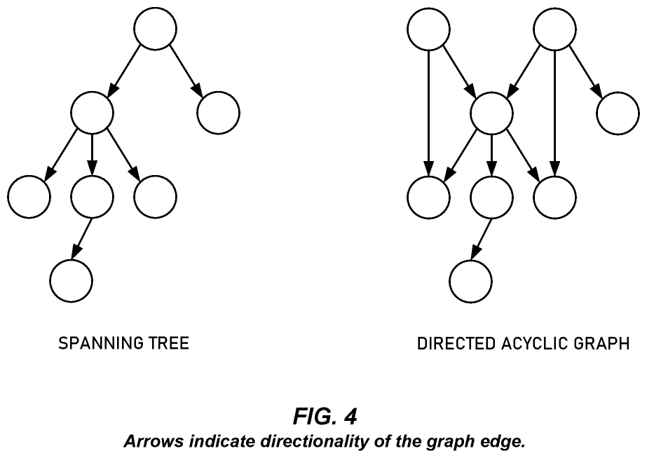

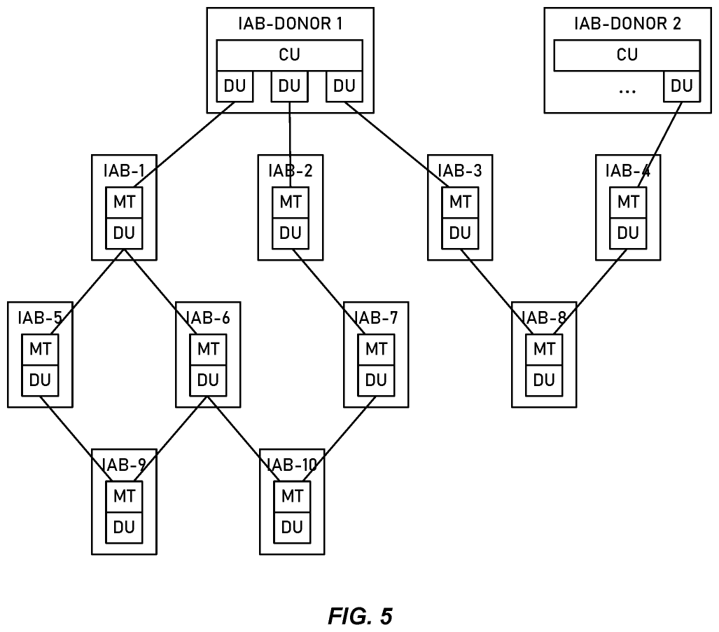

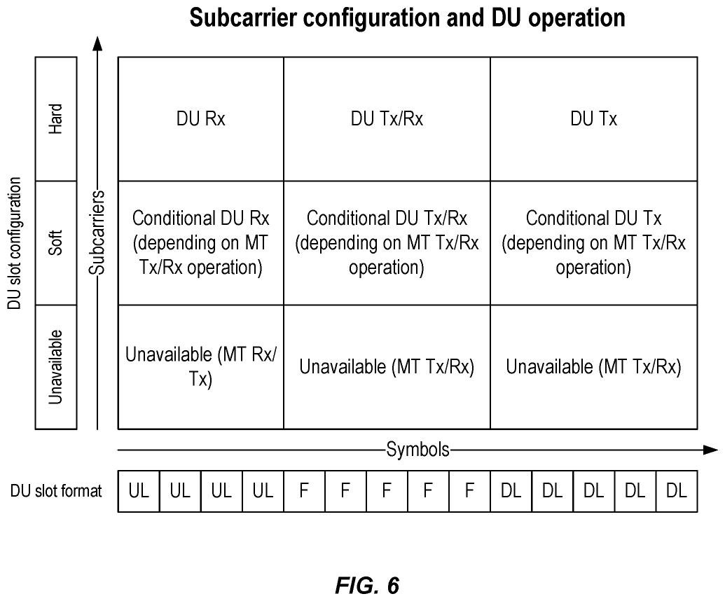

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

IAB-Node: As used herein, an Integrated Access and Backhaul (IAB) node is a RAN node that supports wireless access to UEs and utilizes parts of the radio resources to wirelessly backhaul the access traffic.

IAB-Donor Node: As used herein, an IAB-donor node or simply “IAB-donor” is a node that connects to the core network (e.g., via wired connection such as, e.g., a fiber connection). The IAB-donor includes a Central Unit (CU). Note that an IAB-donor node may also be an IAB-node. For instance, a donor IAB-node is a parent IAB-node.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). The current specification does not allow for spatial domain multiplexing between IAB Mobile Termination (MT) and IAB Distributed Unit (DU) operations. Hence, resources are not used to their full potential in terms of network capacity. Furthermore, Spatial Division Multiplexing (SDM) implies certain challenges to child IAB-nodes or UEs that may be located in a similar direction as the parent IAB-node such that these nodes become inaccessible. Hence, there is a need for a method to indicate restriction or accessibility of the spatial resources of the IAB-DU.

Certain aspects of the present disclosure and their embodiments may provide solutions to the aforementioned or other challenges. Embodiments that relate to IAB-node simultaneous operation with beam reciprocity, or simultaneous transmission without beam reciprocity, are disclosed herein. In this regard, in one embodiment, a method in an IAB-node for spatial domain simultaneous operation with a parent IAB-node and a child IAB-node or a UE comprises transmitting reference signals in reference transmit (Tx) beams and receiving a beam restriction configuration related to the reference beams.

In one embodiment, the method further comprises, prior to transmitting the reference signals, transmitting a capability report to a CU (e.g., of the associated IAB donor node) where the capability report comprises information that indicates a capability for spatial domain simultaneous operation and receiving a Hard (H)/Soft (S) /Not Available (NA) resource configuration from the CU.

In one embodiment, the method further comprises, upon receiving the beam restriction configuration, identifying a need for communicating with a child IAB-node or a UE, determining (e.g., based on the beam restriction configuration) a serving beam towards the child IAB-node or UE that is not restricted for spatial domain simultaneous operation, scheduling resources for operations towards the child IAB-node or the UE, and transmitting or receiving data from a child IAB-node or UE on the scheduled resources with the determined serving beam. In one embodiment, the resources are Soft or NA.

In one embodiment, prior to determining the serving beam, upon receiving an availability indicator for the Soft resource from the parent IAB-node, scheduling the child node or UE even if the determined serving beam is a restricted beam.

In one embodiment, the beam restriction configuration is received from the parent IAB-node or the CU.

In one embodiment, the reference signals comprise Synchronization Signal Blocks (SSBs), Channel State Information Reference Signals (CSI-RSs), and/or Sounding Reference Signals (SRSs).

Embodiments of a parent IAB-node and corresponding embodiments of a method of operation of a parent IAB-node (matching IAB-node simultaneous operation with beam reciprocity, or simultaneous transmission without beam reciprocity, embodiments) are also disclosed herein. In one embodiment, a method in a parent IAB-node for communicating with an IAB-node, capable of spatial domain simultaneous operation, comprises receiving reference signals in reference Tx beams from the IAB-node using a serving receive (Rx) beam, determining a set of restricted beams for spatial domain simultaneous operation, and signaling a configuration including the set of restricted beams (e.g., to the IAB-node).

In one embodiment, the method further comprises, prior to receiving reference signals, receiving information that the IAB-node is capable of spatial domain simultaneous operation.

In one embodiment, the reference signals are SSBs, SRSs, and/or CSI-RSs.

Embodiments of an IAB-node and corresponding embodiments of a method of operation of an IAB-node for simultaneous reception without beam reciprocity are also disclosed herein. In one embodiment, a method in an IAB-node for spatial domain simultaneous reception with a parent IAB-node and a child IAB-node or a UE comprises receiving a reference signal in a serving Tx beam from the parent IAB-node by sweeping multiple reference Rx beams and determining a set of restricted Rx beams for spatial domain simultaneous operation.

In one embodiment, the method further comprises, prior to receiving the reference signal, transmitting a capability report to a CU, including a capability for spatial domain simultaneous operation, and receiving an H/S/NA resource configuration from the CU.

In one embodiment, the method further comprises, upon determining of resources, identifying a need for communicating with a child IAB-node or a UE, determining a serving Rx beam towards the child IAB-node or UE is not restricted for spatial domain simultaneous operation, scheduling resources for operations towards the child IAB-node or the UE, and receiving data from a child IAB-node or UE on the scheduled resources using the serving Rx beam.

In one embodiment, the method further comprises, upon receiving an availability indicator (AI) for the Soft resource from the parent IAB-node, scheduling the child node or UE even if the determined serving beam is a restricted beam.

Certain embodiments may provide one or more of the following technical advantage(s). Embodiments of the present disclosure allow an IAB-node to operate in spatial domain simultaneous operation, meaning that both the IAB-MT and IAB-DU can operate (transmit and/or receive) using the same time-frequency resources. In doing so, the capacity of the IAB-node can be greatly increased, in turn resulting in increased network performance, reduced latency, and improved user experience.

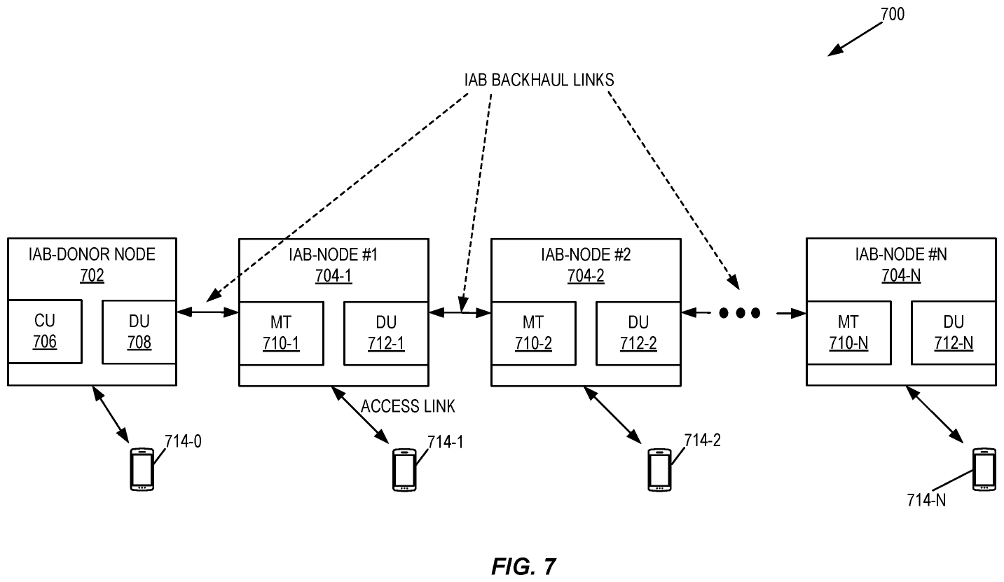

FIG. 7 illustrates one example of a radio access network (RAN) 700, which is also referred to herein as an IAB network, in which embodiments of the present disclosure may be implemented. In the embodiments described herein, the RAN 700 is a Next Generation RAN (NG-RAN) (which is part of a 5G System (5GS) which includes the NG-RAN and a Fifth Generation Core (5GC)) or an Evolved Universal Terrestrial Radio Access Network (E-UTRAN) (which is part of an Evolved Packet System (EPS) which includes the E-UTRAN and an Evolved Packet Core (EPC)). As will be appreciated by those of skill in the art, the RAN 700 includes an IAB-donor node 702 and a number of IAB-nodes 704-1 through 704-N. The IAB-donor node 702 includes a Central Unit (CU) 706 (also referred to herein as IAB-donor-CU 706) and a Distributed Unit (DU) 708 (also referred to herein as IAB-donor-DU 708). The CU 705 is a logical unit responsible for higher level functions, e.g., RRC. The IAB-donor node 702 preferably has a wired backhaul connection to the core network (not shown). The IAB-nodes 704-1 through 704-N include respective Mobile Termination units (MTs) 710-1 through 710-N (also referred to herein as IAB-MTs 710-1 through 710-N) and respective DUs 712-1 through 712-N (also referred to herein as IAB-DUs 712-1 through 712-N). The IAB-nodes 704-1 through 704-N are generally referred to herein as IAB-nodes 704. The IAB-nodes 704 and optionally in this example the IAB-donor node 702 provide radio access to respective wireless communication devices (WCDs) 714-0 through 714-N, which are generally referred to herein as WCDs 714. Note that only one WCD 714 is illustrated for each of the IAB-donor node 702 and IAB-nodes 704 for clarity, it should be appreciated that each of the IAB-donor node 702 and IAB-nodes 704 may provide radio access to many WCDs 714. Further, while not illustrated in FIG. 7, a single IAB-node 704 may have multiple child IAB-nodes and/or multiple parent IAB-nodes. It should also be noted that, for any IAB-node 704-i, the IAB-node 704-i is connected downstream to its child node and/or a WCD(s) 714 and connected upstream to its parent node. Thus, the IAB-node 704-(i+1) is the child node of the IAB-node 704-i, and the IAB-node 704-(i−1) is the parent node of the IAB-node 704-i. For simplicity, the parent IAB-node is also denoted herein as 704-p, and the child IAB-node is also denoted herein as 704-c. Also note that the IAB-donor node 702 can be seen as the parent IAB-node of the IAB-node 704-1.

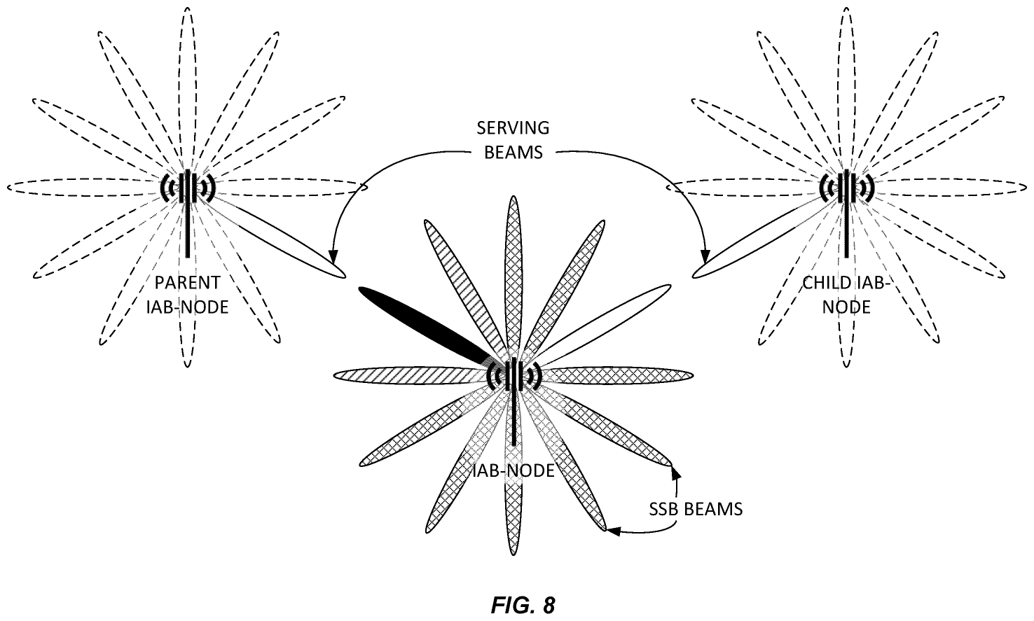

FIG. 8 is an illustration of the SSB beams of an IAB-node 704-i and the serving beams of the parent and child IAB-nodes 704-p and 704-c. Note that in the following description of FIG. 8, reference numbers of the corresponding elements in FIG. 7 are used. The black SSB beam, or a beam related to the black SSB beam, of the IAB-node 704-i is used for serving the IAB-MT 710-i when communicating with the IAB-DU 712-p of the parent IAB-node 704-p, whereas the white beam is used for serving the IAB-DU 712-i of the IAB-node 704-i when communicating with the IAB-MT 710-c of the child IAB-node 704-c. The parent IAB-node's and child IAB-node's respective serving beams are indicated with solid lines.

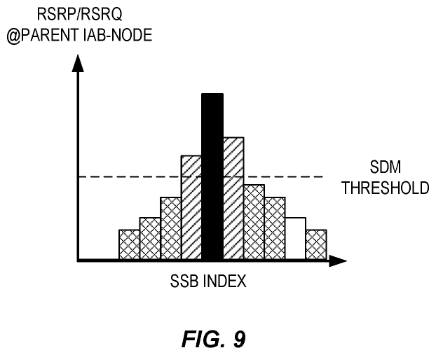

FIG. 9 is an illustration of received signal strength of different SSB beams at the parent IAB-node 704-p. Patterns are aligned with FIG. 8. Some beams may not be detected by the parent IAB-node 704-p.

The IAB-DU 712-i transmits SSB beams in the directions it provides coverage, see, e.g., FIG. 8. In FIG. 8, the solid black beam, or a beam related to it, is the one identified by the parent IAB-node 704-p as the one being preferred for the IAB-MT 710-i to use when communicating with the parent IAB-node 704-p, i.e., it is the serving beam of the IAB-MT 710-i when communicating with the parent IAB-node 704-p. The white SSB beam, or a beam related to it, is preferred when the IAB-DU 712-i communicates with the IAB-MT 710-c of its child IAB-node 704-c, i.e., it is used when serving the child IAB-MT 710-c. The striped SSB beams are beams causing significant interference (e.g., above a threshold for spatial domain multiplexing in simultaneous operation) in the parent IAB-node 704-p when the parent IAB-node 704-p is receiving the black beam, using its serving beam for communication with the IAB-MT 710-i, and the checked SSB beams are beams causing insignificant interference in the parent IAB-node 704-p when receiving the black beam, using its serving beam for communication with the IAB-MT 710-i, see FIG. 9. As can be illustrated in FIG. 8, the parent IAB-node 704-p may not be able to receive all beams from the IAB-node 704-i.

Embodiments of the present disclosure relate to three main aspects. As described below in detail, a first aspect relates to one IAB-node simultaneous operation and, more specifically, to a general spatial domain simultaneous operation scenario where the operation can be either transmit or receive, depending on the slot configuration, downlink (DL), uplink (UL) or flexible (F) slot, and where reciprocity is assumed between Tx and Rx beams, and hence, no distinction is made between Tx and Rx beams although the terms may be used for ease of understanding. Alternatively, the first aspect only concerns spatial domain simultaneous transmission in which case the third aspect may be used for spatial domain simultaneous reception. A second, related aspect is a parent IAB-node aspect corresponding to the first aspect. The third aspect is an IAB-node simultaneous reception aspect relating to a spatial domain simultaneous reception scenario, e.g., for the case where non-reciprocal beams are assumed, or if the IAB-node is allowed to determine the restricted beams on its own. While embodiments related to these aspects are described below in separate subsections, these embodiments may be used separately or in any desired combination.

First Aspect: IAB-Node Simultaneous Operation with Beam Reciprocity (or Transmission without Reciprocity)

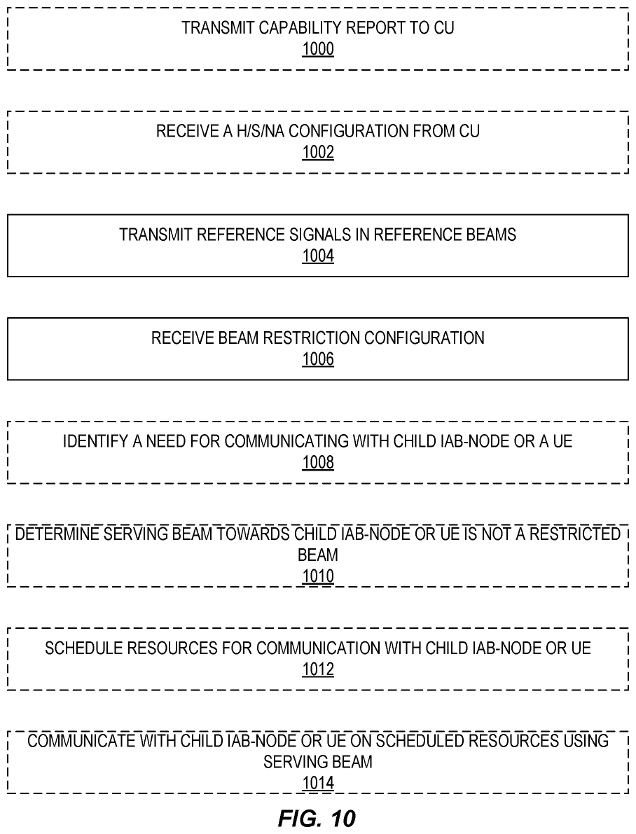

One embodiment of the first aspect of the present disclosure is a method in a IAB-node 704-i for communicating with a parent IAB-node 704-p and a child IAB-node 704-c or a WCD 714 in a spatial domain simultaneous operation mode. This method is illustrated in FIG. 10. Note that optional steps are represented by dashed boxes.

In step 1004, the IAB-node 704-i transmits reference signals in reference beams. These reference signals may include or be SSBs, SRSs, CSI-RSs and/or some other well-defined reference signal. In the communication with the parent IAB-node 704-p, the UL (PUCCH/PUSCH) channels will be transmitted using the same, or related, spatial properties, i.e., beams, as the transmission of an associated reference signal(s), e.g., SSB, SRS; while the DL (PDCCH/PDSCH) channels are received using the same, or related, spatial properties (quasi co-located QCL relation), i.e., beams, as the reception of an associated reference signal(s), e.g., SSB, CSI-RS. In the communication with the child IAB-node 704-c, the DL (PDCCH/PDSCH) channels will be transmitted using the same spatial properties, i.e., beam, as the transmission of an associated reference signal(s); while the UL (PDCCH/PDSCH) channels are received using the same spatial properties i.e., beam, as the reception of an associated reference signal(s). A reference beam, as used herein, is a beam that is unambiguously associated to a reference signal. It is further understood that the reference signal is linked to a reference beam and, hence, implicitly, properties of the reference signal, e.g., received power, may also relate to properties of the beam.

In step 1006, the IAB-node 704-i receives a configuration of a set of restricted beams. This configuration is sometimes referred to herein as a beam restriction configuration or the like. The configuration of the set of restricted beams may refer to a set of reference beams that are determined to cause too much interference (e.g., interference above a predefined or configured threshold amount of interference) in the parent IAB-node 704-p when communicating with the IAB-MT 710-i. Related to a newly agreed specification text for implicit Soft resource availability indication, which will appear in the next version of 3GPP TS 38.213, v16.6,
the IAB-MT would transmit or receive during the symbol of the IAB-DU cell, and the transmission or reception during the symbol of the IAB-DU cell is not changed due to a use of the symbol by the IAB-DU,
   the set of restricted beams includes beams that will cause a transmission or reception by the IAB-MT 710-i, using its serving beam for communication with the parent IAB-node 704-p, to be changed (i.e., interfered) due to the IAB-DU 712-i, simultaneously and using the same time-frequency resources, using a beam associated with the set of restricted beams.

Beams may be restricted, e.g., by having a too high reference signal received power (RSRP) or reference signal received quality (RSRQ) in relation to a threshold. The threshold could be a fixed value or related to the RSRP or RSRQ of the received reference signal from the IAB-node 704-i to the parent IAB-node 704-p using their respective serving beams, or related to possible other devices that the parent IAB-node 704-p communicates with simultaneously and other metrics are not precluded.

In an optional step 1000, prior to step 1004, the IAB-node 704-i transmits a capability report to a CU (e.g., CU 706), to which it is associated, including a capability of spatial domain simultaneous operation.

In an optional subsequent step 1002, the IAB-node 704-i receives one or more H/S/NA configurations from the CU (e.g., CU 706), in order to know which resources are allowed, conditionally allowed, or disallowed to be used by the IAB-DU 712-i. The H/S/NA configuration may be a time domain, frequency domain, or a combined time and frequency configuration. A further configuration may be that Spatial Division Multiplexing (SDM) is enabled for the IAB-node 704-i.

In an optional step 1008, subsequent to step 1006, the IAB-node 704-i identifies a need for communication with a child IAB-node 704-c or a WCD 714. The need may arise from receiving data or a control message from the parent IAB-node 704-p or from the child IAB-node 704-c or WCD 714, or from the CU (e.g., CU 706).

In an optional step 1010, the IAB-node 704-i determines that the serving beam for communication with the child IAB-node 704-c or the WCD 714 is not in the set of restricted beams for spatial domain simultaneous operation, or associated with a beam in the set of restricted beams. It may be noted that the serving beam for communication with the child IAB-node 704-c or the WCD 714 may not be in the set of reference beams, e.g., the serving beam may be a CSI-RS beam and the reference beam may be an SSB beam. The serving beam and reference beam may still be associated in a way such that it is possible to determine that the serving beam for communication with the child IAB-node 704-c or WCD 714 is not restricted for use if the associated reference beam is not restricted for use, i.e., in the set of restricted beams. Hence, in accordance with the existing specification text, the IAB-node 704-i determines that the signal the IAB-MT 710-i would transmit or receive is not changed due to the spatial domain multiplexing of the serving beam used by the IAB-DU 712-i for communication with a child IAB-node 704-c or a WCD 714. Hence, the IAB-node 704-i can determine that spatial domain simultaneous operation is implicitly available in a Soft resource. Alternatively, or additionally, a corresponding decision may be made for Not Available (NA) resources.

In an optional step 1012, the IAB-node 704-i schedules resources for communications with the child IAB-node 704-c or the WCD 714.

In a final optional step 1014, the IAB-node 704-i communicates with the child IAB-node 704-c or WCD 714 on the scheduled resources using the serving beam for communication.

All the above may be used for both simultaneous transmission and simultaneous reception communications with the parent IAB-node 704-p and the child IAB-node(s) 704-c or the WCD(s) 714 if beam reciprocity is assumed such that the same beam is used for both reception and transmission for a particular counterpart node. Alternatively, without beam reciprocity, the above may be limited to simultaneous transmission communication with the parent IAB-node 704-p and the child IAB-node(s) 704-c or WCD(s) 714. In that case, the IAB-node 704-i simultaneous reception aspect below will take care of the simultaneous reception communication including the parent IAB-node 704-p. It can further be noted that the parent node communication is not included since it does not differ compared to existing specification. Beam reciprocity may be part of the configuration signaling in step 1002. Moreover, beam correspondence between IAB-MT beams and IAB-DU beams is assumed, such that both parts are able to use the same fundamental beams or beams related to the same reference beams. This is however not a necessary requirement for embodiments of the present disclosure to function, but simplifies description.

In one embodiment, upon receiving a resource availability indication from the parent IAB-node 704-p, the IAB-DU 712-i can also schedule communication with a child IAB-node 704-c or a WCD 714 using beams within the restricted beam set and on a resource related to the availability indication. The resource availability indication can be, for example, a dynamic downlink control information (DCI) signaling and the resource may be a beam, a time resource, a frequency resource, or a time-frequency resource.

Second Aspect: Parent IAB-Node Aspect (Matching IAB-Node Simultaneous Operation with Beam Reciprocity)

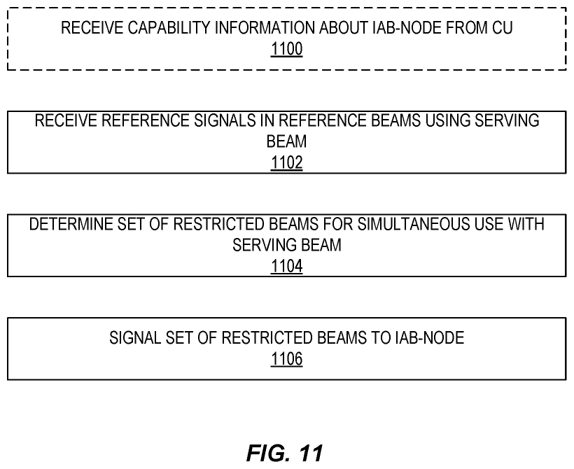

One embodiment of the second aspect of the present disclosure is a method in a parent IAB-node 704-p for communicating with a IAB-node 704-i that is capable of spatial domain simultaneous operation. This method is illustrated in FIG. 11. Note that optional steps are represented by dashed boxes. The objective of the parent node 704-p is to configure the IAB-node 704-i such that any IAB-DU beams that are part of the spatial domain simultaneous operation do not interfere with the IAB-MT's serving beam for communication with the parent IAB-node 704-p.

In step 1102, the parent IAB-node 704-p receives reference signals in reference beams from the IAB-node 704-i by using a serving Rx beam for communication with the IAB-MT 710-i. Details of these reference signals and reference beams are given in the description of step 1004 of FIG. 10 above. Hence, the parent node 704-p uses the same serving Rx beam to receive multiple, different reference signals and reference beams transmitted by the IAB-node 704-i.

In step 1104, the parent IAB-node 704-p determines a set of restricted beams from the received reference signals and reference beams, the set of restricted beams being restricted for spatial domain simultaneous operation where the parent IAB-node 704-p, using its serving Rx beam, is one part of the simultaneous operation. Beams may be restricted, e.g., by having a too high reference signal received power (RSRP) or reference signal received quality (RSRQ) in relation to a threshold. The threshold could be a fixed value or related to the RSRP or RSRQ of the received reference signal from the IAB-node 704-i to the parent IAB-node 704-p using their respective serving beams, or related to possible other devices that the parent IAB-node 704-p communicates with simultaneously and other metrics are not precluded. Referring to FIG. 8 and FIG. 9, where, in FIG. 8, the black beam is the IAB-MT's serving Tx beam for communication with the parent IAB-node 704-p, the parent IAB-node 704-p may identify a threshold that may be set either in absolute terms or in relation to the RSRP of the received reference signal as provided by IAB-MT's serving Tx beam and received by the parent IAB-node's serving Rx beam. As presented in FIG. 9, beams exceeding the threshold value are precluded from being used for spatial domain simultaneous operation in combination with the IAB-MT's serving Tx beam for communication with the parent IAB-node 704-p using its serving Rx beam. The threshold value may further depend on the overall interference situation at the IAB parent node 704-p such that a situation with more interference will result in a higher threshold since a stronger interfering node will make less difference compared to other interference. Interference based thresholds may be used particularly if non-reciprocal beams are assumed.

In step 1106, the parent IAB-node 704-p signals the set of restricted beams to the IAB-node 704-i. This may be done with, e.g., DCI signaling or MAC CE including a representation of the set of restricted beams. The signaling may additionally contain a set of serving beams, e.g., a second, backup serving beam in addition to a first serving beam, where a set of restricted beams is provided for each serving beam in the set of serving beams.

In an optional step 1100, prior to step 1102, the parent IAB-node 704-p may have received information from a CU (e.g., CU 706), to which both the parent IAB-node 704-p and the IAB-node 704-i are associated, that indicates that the IAB-node 704-i is capable of spatial domain simultaneous operation.

In case beam reciprocity is assumed, the serving Rx beam and serving Tx beam in a node, for communication with another node, will be the same. In case of no reciprocity, a serving Rx beam and a serving Tx beam may differ.

Third Aspect: IAB-Node Simultaneous Operation without Beam Reciprocity (or Reception)

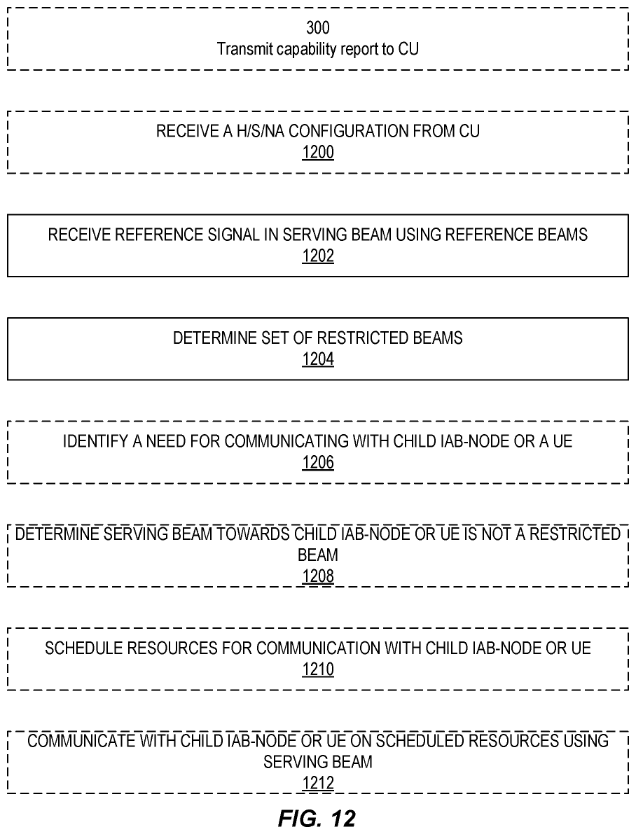

In an IAB-node simultaneous reception aspect, the set of restricted beams are not assumed to be reciprocal, i.e., different beams may be used for UL and DL between the parent IAB-node 704-p and the IAB-MT 710-i of the IAB-node 704-i. Alternatively, the IAB-node 704-i is allowed to independently determine the set of restricted beams or the reception situations may differ, e.g., due to different level of interference, such that different sets of restricted beams are desirable in different directions. Hence, one embodiment of the third aspect of the present disclosure is a method in an IAB-node 704-i for spatial domain simultaneous reception with a parent IAB-node 704-p and a child IAB-node 704-c or WCD 714. This method is illustrated in FIG. 12 where optional steps are represented by dashed boxes.

In step 1204, the IAB-node 704-i sweeps multiple reference Rx beams in order to receive a reference signal in a serving Tx beam of the parent IAB-node 704-p. The serving Tx beam may be the beam that the parent IAB-node 704-p has determined to use in communication with the IAB-MT 710-i of the IAB-node 704-i, or a beam that is associated to the beam to use in communication with the IAB-MT 710-i of the IAB-node 704-i. Hence, the IAB-node 704-i uses different reference Rx beams to receive multiple instances of a single reference signal in a single serving Tx beam, transmitted by the parent IAB-node 704-p.

In step 1206, the IAB-node 704-i may determine a set of restricted Rx beams for which spatial domain simultaneous reception is not feasible, while simultaneously receiving a serving Tx beam for communication with the parent IAB-node 704-p. From the set of restricted Rx beams, other beams that are associated to beams in the set of restricted Rx beams may also be restricted from use, e.g., an SRS beam, i.e., a beam used for receiving an SRS from a child IAB-node 704-c or WCD 714, where the SRS beam is related to a reference Rx beam that is in the set of restricted Rx beams, may also be restricted from use. The set of restricted Rx beams may be determined as in step (1104) of FIG. 11. The set of restricted Rx beams may further be related to the device type the IAB-node 704-i is receiving from with a certain beam, i.e., there exists a restricted set for each device type. For example, the acceptable interference while receiving from a WCD 714 or a local area IAB-node may be substantially smaller than the acceptable interference when receiving from a wide area IAB-node due to the lower transmission power from the former types. Traffic load may also be included in determining the restricted set, in that a lower traffic load may result in an acceptance for higher interference levels.

In an optional step 1200, prior to step 1204, the IAB-node 704-i transmits a capability report to a CU (e.g., CU 706), to which it is associated, including a capability of spatial domain simultaneous operation.

In an optional subsequent step 1202, the IAB-node 704-i receives one or more H/S/NA configurations from the CU (e.g., CU 706), in order to know which resources are disallowed, conditionally allowed, or disallowed to be used by the IAB-DU 712-i of the IAB-node 704-i. The H/S/NA configuration may be a time domain, frequency domain or a combined time and frequency configuration. The IAB-node 704-i may also receive a configuration to operate in spatial domain simultaneous operation.

Optional steps 1208-1214, subsequent to step 1206, follow from steps 1008-1014 of FIG. 10 with focus on reception instead of transmission or reception.

In one embodiment, upon receiving a beam availability indication from the parent IAB-node 704-p, the IAB-DU 712-i of the IAB-node 704-i can also schedule communication with a child IAB-node 704-c or a WCD 714 using beams within the restricted beam set and on a resource related to the availability indication. The beam availability indication can be, e.g., a dynamic DCI signaling.

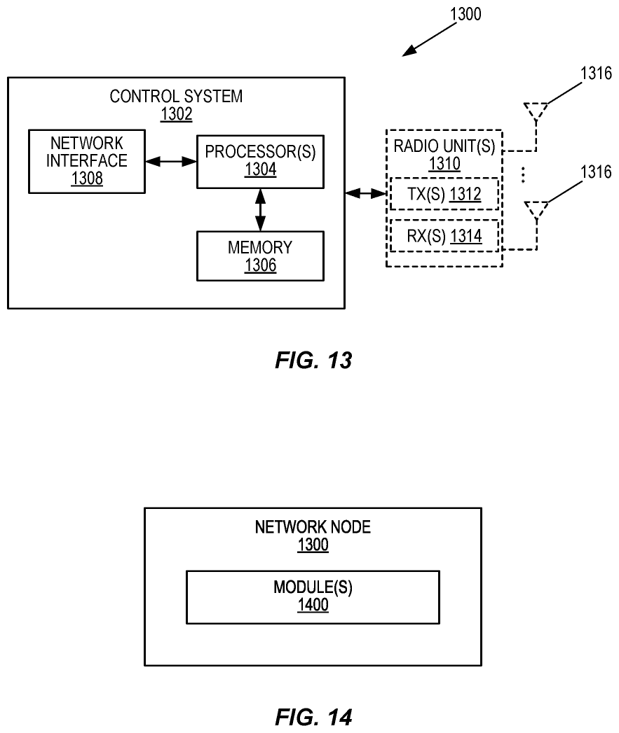

FIG. 13 is a schematic block diagram of a network node 1300 according to some embodiments of the present disclosure. Optional features are represented by dashed boxes. The network node 1300 may be, for example, a network node that implements the IAB-donor node 702 or one of the IAB-nodes 704-i as described herein. As illustrated, the network node 1300 includes a control system 1302 that includes one or more processors 1304 (e.g., Central Processing Units (CPUs), Application Specific Integrated Circuits (ASICs), Field Programmable Gate Arrays (FPGAs), and/or the like), memory 1306, and optionally a network interface 1308. The one or more processors 1304 are also referred to herein as processing circuitry. In addition, the network node 1300 includes one or more radio units 1310 that each includes one or more transmitters 1312 and one or more receivers 1314 coupled to one or more antennas 1316. The radio units 1310 may be referred to or be part of radio interface circuitry. In some embodiments, the radio unit(s) 1310 is external to the control system 1302 and connected to the control system 1302 via, e.g., a wired connection (e.g., an optical cable). However, in some other embodiments, the radio unit(s) 1310 and potentially the antenna(s) 1316 are integrated together with the control system 1302. The one or more processors 1304 operate to provide one or more functions of the network node 1300 as described herein (e.g., one or more functions of the IAB-donor node 702 or one or more functions of the IAB-node 704, as described above). In some embodiments, the function(s) are implemented in software that is stored, e.g., in the memory 1306 and executed by the one or more processors 1304.

FIG. 14 is a schematic block diagram of the network node 1300 according to some other embodiments of the present disclosure. The network node 1300 includes one or more modules 1400, each of which is implemented in software. The module(s) 1400 provide the functionality of the network node 1300 described herein (e.g., one or more functions of the IAB-donor node 702 or one or more functions of the IAB-node 704, as described above).

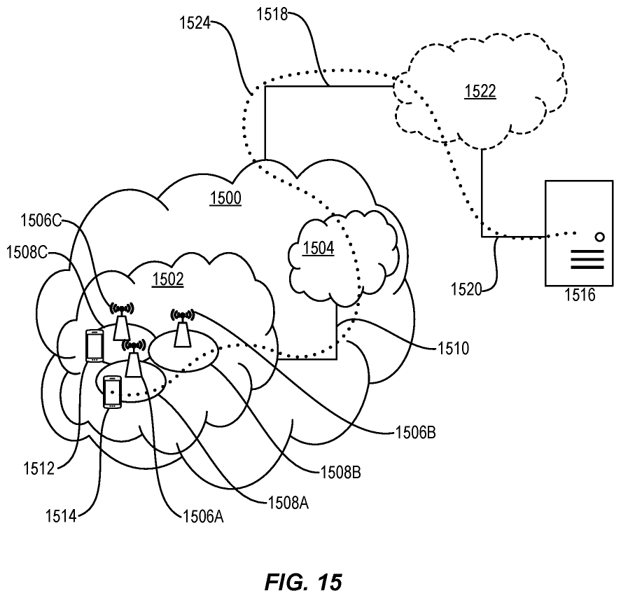

With reference to FIG. 15, in accordance with an embodiment, a communication system includes a telecommunication network 1500, such as a 3GPP-type cellular network, which comprises an access network 1502, such as a RAN, and a core network 1504. The access network 1502 comprises a plurality of base stations 1506A, 1506B, 1506C, such as Node Bs, eNBs, gNBs, or other types of wireless Access Points (APs), each defining a corresponding coverage area 1508A, 1508B, 1508C. Each base station 1506A, 1506B, 1506C is connectable to the core network 1504 over a wired or wireless connection 1510. A first UE 1512 located in coverage area 1508C is configured to wirelessly connect to, or be paged by, the corresponding base station 1506C. A second UE 1514 in coverage area 1508A is wirelessly connectable to the corresponding base station 1506A. While a plurality of UEs 1512, 1514 are illustrated in this example, the disclosed embodiments are equally applicable to a situation where a sole UE is in the coverage area or where a sole UE is connecting to the corresponding base station 1506.

The telecommunication network 1500 is itself connected to a host computer 1516, which may be embodied in the hardware and/or software of a standalone server, a cloud-implemented server, a distributed server, or as processing resources in a server farm. The host computer 1516 may be under the ownership or control of a service provider, or may be operated by the service provider or on behalf of the service provider. Connections 1518 and 1520 between the telecommunication network 1500 and the host computer 1516 may extend directly from the core network 1504 to the host computer 1516 or may go via an optional intermediate network 1522. The intermediate network 1522 may be one of, or a combination of more than one of, a public, private, or hosted network; the intermediate network 1522, if any, may be a backbone network or the Internet; in particular, the intermediate network 1522 may comprise two or more sub-networks (not shown).

The communication system of FIG. 15 as a whole enables connectivity between the connected UEs 1512, 1514 and the host computer 1516. The connectivity may be described as an Over-the-Top (OTT) connection 1524. The host computer 1516 and the connected UEs 1512, 1514 are configured to communicate data and/or signaling via the OTT connection 1524, using the access network 1502, the core network 1504, any intermediate network 1522, and possible further infrastructure (not shown) as intermediaries. The OTT connection 1524 may be transparent in the sense that the participating communication devices through which the OTT connection 1524 passes are unaware of routing of uplink and downlink communications. For example, the base station 1506 may not or need not be informed about the past routing of an incoming downlink communication with data originating from the host computer 1516 to be forwarded (e.g., handed over) to a connected UE 1512. Similarly, the base station 1506 need not be aware of the future routing of an outgoing uplink communication originating from the UE 1512 towards the host computer 1516.

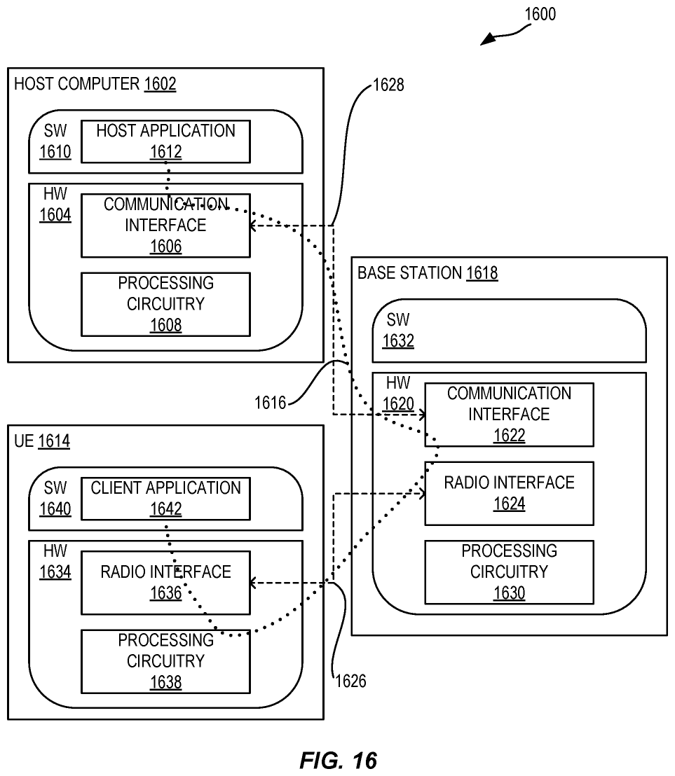

Example implementations, in accordance with an embodiment, of the UE, base station, and host computer discussed in the preceding paragraphs will now be described with reference to FIG. 16. In a communication system 1600, a host computer 1602 comprises hardware 1604 including a communication interface 1606 configured to set up and maintain a wired or wireless connection with an interface of a different communication device of the communication system 1600. The host computer 1602 further comprises processing circuitry 1608, which may have storage and/or processing capabilities. In particular, the processing circuitry 1608 may comprise one or more programmable processors, ASICS, FPGAS, or combinations of these (not shown) adapted to execute instructions. The host computer 1602 further comprises software 1610, which is stored in or accessible by the host computer 1602 and executable by the processing circuitry 1608. The software 1610 includes a host application 1612. The host application 1612 may be operable to provide a service to a remote user, such as a UE 1614 connecting via an OTT connection 1616 terminating at the UE 1614 and the host computer 1602. In providing the service to the remote user, the host application 1612 may provide user data which is transmitted using the OTT connection 1616.

The communication system 1600 further includes a base station 1618 provided in a telecommunication system and comprising hardware 1620 enabling it to communicate with the host computer 1602 and with the UE 1614. The hardware 1620 may include a communication interface 1622 for setting up and maintaining a wired or wireless connection with an interface of a different communication device of the communication system 1600, as well as a radio interface 1624 for setting up and maintaining at least a wireless connection 1626 with the UE 1614 located in a coverage area (not shown in FIG. 16) served by the base station 1618. The communication interface 1622 may be configured to facilitate a connection 1628 to the host computer 1602. The connection 1628 may be direct or it may pass through a core network (not shown in FIG. 16) of the telecommunication system and/or through one or more intermediate networks outside the telecommunication system. In the embodiment shown, the hardware 1620 of the base station 1618 further includes processing circuitry 1630, which may comprise one or more programmable processors, ASICs, FPGAs, or combinations of these (not shown) adapted to execute instructions. The base station 1618 further has software 1632 stored internally or accessible via an external connection.

The communication system 1600 further includes the UE 1614 already referred to. The UE's 1614 hardware 1634 may include a radio interface 1636 configured to set up and maintain a wireless connection 1626 with a base station serving a coverage area in which the UE 1614 is currently located. The hardware 1634 of the UE 1614 further includes processing circuitry 1638, which may comprise one or more programmable processors, ASICS, FPGAs, or combinations of these (not shown) adapted to execute instructions. The UE 1614 further comprises software 1640, which is stored in or accessible by the UE 1614 and executable by the processing circuitry 1638. The software 1640 includes a client application 1642. The client application 1642 may be operable to provide a service to a human or non-human user via the UE 1614, with the support of the host computer 1602. In the host computer 1602, the executing host application 1612 may communicate with the executing client application 1642 via the OTT connection 1616 terminating at the UE 1614 and the host computer 1602. In providing the service to the user, the client application 1642 may receive request data from the host application 1612 and provide user data in response to the request data. The OTT connection 1616 may transfer both the request data and the user data. The client application 1642 may interact with the user to generate the user data that it provides.

It is noted that the host computer 1602, the base station 1618, and the UE 1614 illustrated in FIG. 16 may be similar or identical to the host computer 1516, one of the base stations 1506A, 1506B, 1506C, and one of the UEs 1512, 1514 of FIG. 15, respectively. This is to say, the inner workings of these entities may be as shown in FIG. 16 and independently, the surrounding network topology may be that of FIG. 15.

In FIG. 16, the OTT connection 1616 has been drawn abstractly to illustrate the communication between the host computer 1602 and the UE 1614 via the base station 1618 without explicit reference to any intermediary devices and the precise routing of messages via these devices. The network infrastructure may determine the routing, which may be configured to hide from the UE 1614 or from the service provider operating the host computer 1602, or both. While the OTT connection 1616 is active, the network infrastructure may further take decisions by which it dynamically changes the routing (e.g., on the basis of load balancing consideration or reconfiguration of the network).

The wireless connection 1626 between the UE 1614 and the base station 1618 is in accordance with the teachings of the embodiments described throughout this disclosure. One or more of the various embodiments improve the performance of OTT services provided to the UE 1614 using the OTT connection 1616, in which the wireless connection 1626 forms the last segment. More precisely, the teachings of these embodiments may improve, e.g., the data rate, latency, and/or power consumption and thereby provide benefits such as, e.g., reduced user waiting time, relaxed restriction on file size, better responsiveness, and/or extended battery lifetime.

A measurement procedure may be provided for the purpose of monitoring data rate, latency, and other factors on which the one or more embodiments improve. There may further be an optional network functionality for reconfiguring the OTT connection 1616 between the host computer 1602 and the UE 1614, in response to variations in the measurement results. The measurement procedure and/or the network functionality for reconfiguring the OTT connection 1616 may be implemented in the software 1610 and the hardware 1604 of the host computer 1602 or in the software 1640 and the hardware 1634 of the UE 1614, or both. In some embodiments, sensors (not shown) may be deployed in or in association with communication devices through which the OTT connection 1616 passes; the sensors may participate in the measurement procedure by supplying values of the monitored quantities exemplified above, or supplying values of other physical quantities from which the software 1610, 1640 may compute or estimate the monitored quantities. The reconfiguring of the OTT connection 1616 may include message format, retransmission settings, preferred routing, etc.; the reconfiguring need not affect the base station 1618, and it may be unknown or imperceptible to the base station 1618. Such procedures and functionalities may be known and practiced in the art. In certain embodiments, measurements may involve proprietary UE signaling facilitating the host computer 1602's measurements of throughput, propagation times, latency, and the like. The measurements may be implemented in that the software 1610 and 1640 causes messages to be transmitted, in particular empty or ‘dummy’ messages, using the OTT connection 1616 while it monitors propagation times, errors, etc.

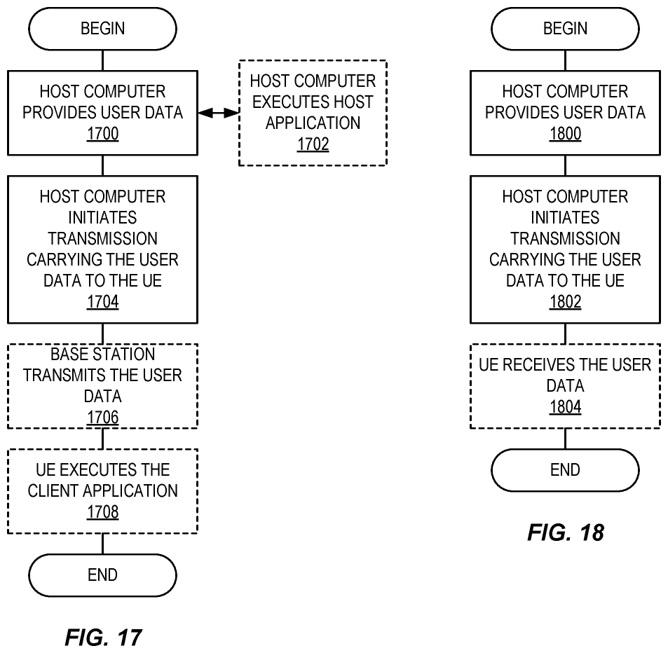

FIG. 17 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 17 will be included in this section. In step 1700, the host computer provides user data. In sub-step 1702 (which may be optional) of step 1700, the host computer provides the user data by executing a host application. In step 1704, the host computer initiates a transmission carrying the user data to the UE. In step 1706 (which may be optional), the base station transmits to the UE the user data which was carried in the transmission that the host computer initiated, in accordance with the teachings of the embodiments described throughout this disclosure. In step 1708 (which may also be optional), the UE executes a client application associated with the host application executed by the host computer.

FIG. 18 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 18 will be included in this section. In step 1800 of the method, the host computer provides user data. In an optional sub-step (not shown) the host computer provides the user data by executing a host application. In step 1802, the host computer initiates a transmission carrying the user data to the UE. The transmission may pass via the base station, in accordance with the teachings of the embodiments described throughout this disclosure. In step 1804 (which may be optional), the UE receives the user data carried in the transmission.

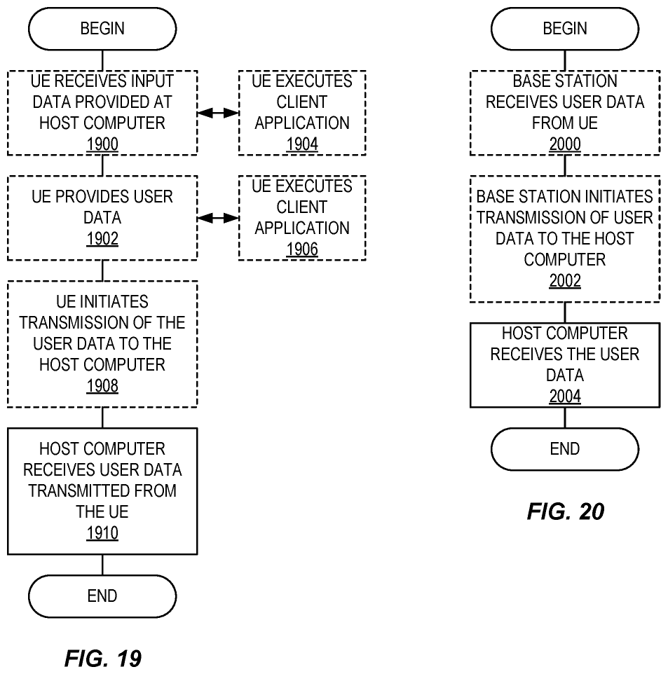

FIG. 19 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 19 will be included in this section. In step 1900 (which may be optional), the UE receives input data provided by the host computer. Additionally or alternatively, in step 1902, the UE provides user data. In sub-step 1904 (which may be optional) of step 1900, the UE provides the user data by executing a client application. In sub-step 1906 (which may be optional) of step 1902, the UE executes a client application which provides the user data in reaction to the received input data provided by the host computer. In providing the user data, the executed client application may further consider user input received from the user. Regardless of the specific manner in which the user data was provided, the UE initiates, in sub-step 1908 (which may be optional), transmission of the user data to the host computer. In step 1910 of the method, the host computer receives the user data transmitted from the UE, in accordance with the teachings of the embodiments described throughout this disclosure.

FIG. 20 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 20 will be included in this section. In step 2000 (which may be optional), in accordance with the teachings of the embodiments described throughout this disclosure, the base station receives user data from the UE. In step 2002 (which may be optional), the base station initiates transmission of the received user data to the host computer. In step 2004 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

### Group A Embodiments

Embodiment 1: A method performed by an Integrated Access and Backhaul, IAB, node (704-i) for spatial domain simultaneous operation with a parent IAB-node (704-p) and a child IAB-node (704-c) or a wireless communication device, WCD, (714), the method comprising: transmitting (1004) reference signals in reference transmit beams; and receiving (1006) a beam restriction configuration related to the reference transmit beams, the beam restriction configuration comprising information that indicates a set of restricted beams for simultaneous spatial domain operation.

Embodiment 2: The method of embodiment 1 further comprising, prior to transmitting (1004) the reference signals in the reference transmit beams, transmitting (1000) a capability report to an associated central unit, CU, (706), wherein the capability report comprises information that indicates a capability of the IAB-node (704-i) for spatial domain simultaneous operation.

Embodiment 3: The method of embodiment 2 further comprising, prior to transmitting (1004) the reference signals in the reference transmit beams, receiving (1002) an H/S/NA resource configuration from the CU (706).

Embodiment 4: The method of any of embodiments 1 to 3 further comprising, upon receiving the beam restriction configuration: identifying (1008) a need for communicating with a child IAB-node (704-c) or a WCD (714); determining (1010) a serving beam towards the child IAB-node (704-c) or the WCD (714) based on the beam restriction configuration (e.g., determining a serving beam towards the child IAB-node that is not restricted for spatial domain simultaneous operation); scheduling (1012) resources for one or more operations towards the child IAB-node (704-c) or the WCD (714); transmitting or receiving (1014) data to or from the child IAB-node (704-c) or the WCD (714) on the scheduled resources using the determined serving beam.

Embodiment 5: The method of embodiment 4 wherein the scheduled resources are Soft or NA.

Embodiment 6: The method of embodiment 4 or 5 further comprising, prior to determining (1010) the serving beam, upon receiving an availability indicator for a Soft resource from the parent IAB-node (704-p), scheduling the child IAB-node (704-c) or the WCD (714) even if the determined serving beam is a restricted beam.

Embodiment 7: The method of any of embodiments 1 to 6 wherein the reference signals comprise SSBs, CSI-RS, and/or SRSs.

Embodiment 8: The method of any of embodiments 1 to 7 wherein the beam restriction configuration is received from the parent IAB-node (704-p) or the CU (706).

Embodiment 9: A method performed by a parent Integrated Access and Backhaul, IAB, node (704-p) for communicating with an IAB-node (704-i) capable of spatial domain simultaneous operation, the method comprising: receiving (1102) reference signals in reference transmit beams from an IAB-node (704-i) using a serving receive beam; determining (1104) a set of restricted beams for spatial domain simultaneous operation; and signaling (1106) a configuration (e.g., to the IAB-node 704-i) including information that indicates the set of restricted beams.

Embodiment 10: The method of embodiment 9 further comprising, prior to receiving (1102) the reference signals, receiving (1100) information that indicates that the IAB-node (704-i) is capable of spatial domain simultaneous operation.

Embodiment 11: The method of embodiment 9 or 10 wherein the reference signals comprise SSBs, SRSs, and/or CSI-RSs.

Embodiment 12: A method performed by an Integrated Access and Backhaul, IAB, node (704-i) for spatial domain simultaneous reception with a parent IAB-node (704-p) and a child IAB-node (704-c) or a wireless communication device, WCD, (714), the method comprising: receiving (1204) a reference signal in a serving transmit beam from a parent IAB-node (704-p) by sweeping multiple reference receive beams; and determining (1206) a set of restricted receive beams for spatial domain simultaneous operation.

Embodiment 13: The method of embodiment 12 further comprising, prior to receiving (1204) the reference signal, transmitting (1200) a capability report to a CU (e.g., CU 706), the capability reporting comprising information that indicates a capability of the IAB-node (704-i) for spatial domain simultaneous operation.

Embodiment 14: The method of embodiment 12 or 13 further comprising receiving (1202) an H/S/NA resource configuration from the CU (706).

Embodiment 15: The method of any of embodiments 12 to 14 further comprising: identifying (1208) a need for communicating with a child IAB-node (704-c) or a WCD (714); determining (1210) a serving receive beam towards the child IAB-node (704-c) or WCD (714) that is not restricted for spatial domain simultaneous operation; scheduling (1212) resources for one or more operations towards the child IAB-node (704-c) or WCD (714); receiving (1214) data from the child IAB-node (704-c) or WCD (714) on the scheduled resources using the serving determined serving beam.

Embodiment 16: The method of embodiment 15 further comprising, upon receiving an availability indicator for the Soft resource from the parent IAB-node (704-p), scheduling the child IAB-node (704-c) or WCD (714) even if the determined serving beam is a restricted beam.

Embodiment 17: The method of any of the previous embodiments, further comprising: obtaining user data; and forwarding the user data to a host computer or a wireless device.

### Group B Embodiments

Embodiment 18: An Integrated Access and Backhaul, IAB, node (704) comprising: processing circuitry configured to perform any of the steps of any of the Group A embodiments; and power supply circuitry configured to supply power to the base station.

Embodiment 19: A communication system including a host computer comprising: processing circuitry configured to provide user data; and a communication interface configured to forward the user data to a cellular network for transmission to a User Equipment, UE; wherein the cellular network comprises an Integrated Access and Backhaul, IAB, node (704) having a radio interface and processing circuitry, the IAB-node's processing circuitry configured to perform any of the steps of any of the Group A embodiments.

Embodiment 20: The communication system of the previous embodiment further including the IAB-node.

Embodiment 21: The communication system of the previous 2 embodiments, further including the UE, wherein the UE is configured to communicate with the IAB-node.

Embodiment 22: The communication system of the previous 3 embodiments, wherein: the processing circuitry of the host computer is configured to execute a host application, thereby providing the user data; and the UE comprises processing circuitry configured to execute a client application associated with the host application.

Embodiment 23: A method implemented in a communication system including a host computer, an Integrated Access and Backhaul, IAB, node (704), and a User Equipment, UE, the method comprising: at the host computer, providing user data; and at the host computer, initiating a transmission carrying the user data to the UE via a cellular network comprising the IAB-node, wherein the IAB-node performs any of the steps of any of the Group A embodiments.

Embodiment 24: The method of the previous embodiment, further comprising, at the IAB-node, transmitting the user data.

Embodiment 25: The method of the previous 2 embodiments, wherein the user data is provided at the host computer by executing a host application, the method further comprising, at the UE, executing a client application associated with the host application.

Embodiment 26: A communication system including a host computer comprising a communication interface configured to receive user data originating from a transmission from a User Equipment, UE, to an Integrated Access and Backhaul, IAB, node (704), wherein the IAB-node comprises a radio interface and processing circuitry, the IAB-node's processing circuitry configured to perform any of the steps of any of the Group A embodiments.

Embodiment 27: The communication system of the previous embodiment further including the IAB-node.

Embodiment 28: The communication system of the previous 2 embodiments, further including the UE, wherein the UE is configured to communicate with the IAB-node.

Embodiment 29: The communication system of the previous 3 embodiments, wherein: the processing circuitry of the host computer is configured to execute a host application; and the UE is configured to execute a client application associated with the host application, thereby providing the user data to be received by the host computer.

Those skilled in the art will recognize improvements and modifications to the embodiments of the present disclosure. All such improvements and modifications are considered within the scope of the concepts disclosed herein.

1. A method performed by an Integrated Access and Backhaul, IAB, node for spatial domain simultaneous operation with a parent IAB-node and a child IAB-node or a wireless communication device, WCD, the method comprising:
transmitting reference signals in reference transmit beams; and
receiving a beam restriction configuration related to the reference transmit beams, the beam restriction configuration comprising information that indicates a set of restricted beams for simultaneous spatial domain operation.

2. The method of claim 1 wherein the set of restricted beams consists of one or more beams that are restricted from being used by a Distributed Unit, DU, of the IAB-node together with a current serving beam of a Mobile Termination, MT, of the IAB-node for simultaneous spatial domain operation.

3. The method of claim 1 further comprising, prior to transmitting the reference signals in the reference transmit beams, transmitting a capability report to an associated central unit, CU, wherein the capability report comprises information that indicates a capability of the IAB-node for spatial domain simultaneous operation.

4. The method of claim 3 further comprising, prior to transmitting the reference signals in the reference transmit beams, receiving a Hard, Soft, and Not Available resource configuration from the CU, wherein the Hard, Soft, and Not Available resource configuration is a time domain resource configuration, a frequency domain resource configuration, or a combined time domain and frequency domain resource configuration and indicates which time, frequency, or both time and frequency resources are allowed, conditionally allowed, or disallowed to be used by a Distributed Unit, DU, of the IAB-node.

5. The method of claim 1 further comprising, upon receiving the beam restriction configuration:
identifying a need for communicating with a child IAB-node or a wireless communication device;
determining a serving beam towards the child IAB-node or the wireless communication device based on the beam restriction configuration;
scheduling resources for one or more operations towards the child IAB-node or the wireless communication device; and
transmitting or receiving data to or from the child IAB-node or the wireless communication device on the scheduled resources using the determined serving beam.

6. The method of claim 5 wherein the scheduled resources are resources that are available for use by the DU subject to control by the CU or resources that are always available for use by the DU.

7. The method of claim 5 further comprising, prior to determining the serving beam, upon receiving an availability indicator for a Soft resource from the parent IAB-node, scheduling the child IAB-node or the wireless communication device even if the determined serving beam is a restricted beam.

8. The method of claim 1 wherein the reference signals comprise synchronization signal blocks, SSBs; channel state information reference signals, CSI-RSs; sounding reference signals, SRSs; or any combination thereof.

9. The method of claim 1 wherein receiving the beam restriction configuration comprises receiving the beam restriction configuration via a Medium Access Control, MAC, Control Element, CE.

10. The method of claim 1 wherein the beam restriction configuration is received from the parent IAB-node or the CU.

11. An Integrated Access and Backhaul, IAB, node for spatial domain simultaneous operation with a parent IAB-node and a child IAB-node or a wireless communication device, WCD, the IAB-node comprising processing circuitry configured to cause the IAB-node to:
transmit reference signals in reference transmit beams; and
receive a beam restriction configuration related to the reference transmit beams, the beam restriction configuration comprising information that indicates a set of restricted beams for simultaneous spatial domain operation.

12. (canceled)

13. A method performed by a parent Integrated Access and Backhaul, IAB, node for communicating with an IAB-node capable of spatial domain simultaneous operation, the method comprising:
receiving reference signals in reference transmit beams from an IAB-node using a serving receive beam;
determining a set of restricted beams for spatial domain simultaneous operation; and
signaling a configuration to the IAB-node, the configuration comprising information that indicates the set of restricted beams.

14. The method of claim 13 wherein the set of restricted beams consists of one or more beams that are restricted from being used by a Distributed Unit, DU, of the IAB-node together with a current serving beam of a Mobile Termination, MT, of the IAB-node for simultaneous spatial domain operation.

15. The method of claim 13 further comprising, prior to receiving the reference signals, receiving information that indicates that the IAB-node is capable of spatial domain simultaneous operation.

16. The method of claim 13 wherein the reference signals comprise synchronization signal blocks, SSBs; channel state information reference signals, CSI-RSs; sounding reference signals, SRSs; or any combination thereof.

17. The method of claim 13 wherein signaling the configuration to the IAB-node comprises signaling the configuration to the IAB-node via a Medium Access Control, MAC, Control Element, CE.

18. A parent Integrated Access and Backhaul, IAB, node for communicating with an IAB-node capable of spatial domain simultaneous operation, the parent IAB-node comprising processing circuitry configured to cause the parent IAB-node to:
receive reference signals in reference transmit beams from an IAB-node using a serving receive beam;
determine a set of restricted beams for spatial domain simultaneous operation; and
signal a configuration to the IAB-node, the configuration comprising information that indicates the set of restricted beams.

19-26. (canceled)
